(19) United States
(12) Patent Application Publication
(10) Pub. No.: US 2022/0118674 A1
(43) Pub. Date: Apr. 21, 2022

(54) A METHOD AND TOOL FOR MANUFACTURING A CONTAINER FROM A THERMOPLASTIC MATERIAL AND CONTAINER

(71) Applicant: SOFTFORM LIMITED, Bridgewater, Somerset (GB)

(72) Inventors: Leigh HANDELL, Bridgewater, Somerset (GB); Martin BAKER, Bridgewater, Somerset (GB)

(21) Appl. No.: 17/424,611

(22) PCT Filed: Jan. 21, 2020
(86) PCT No.: PCT/EP2020/051373

§ 371 Date: Jul. 21, 2021

(30) Foreign Application Priority Data
Jan. 24, 2019 (GB) 1900964.6

(51) Int. Cl. B29C 51/10; B29C 51/08; B29C 51/20; B29C 51/26; B29C 51/30; B29C 51/36

(52) U.S. Cl. CPC B29C 51/10; B29C 51/08; B29C 51/20; B29K 2067/003; B29C 51/306; B29C 51/36; B29C 2791/006; B29C 51/262

(57) ABSTRACT

A tool for thermoforming a container having a base and an upstanding sidewall walls or walls. The tool includes a mould having a profile shaped to form the exterior shape of the container and a plug adapted to be inserted in the mould to define the interior of the container. The plug has a lower face adapted to define the profile of the base of the container. The profile of the lower face of the plug has at least one groove therein defining, in use, a rib upstanding in the interior of the base of the container.

### CROSS-REFERENCE TO RELATED APPLICATION(S)

This is a National Stage Entry into the United States Patent and Trademark Office from International Patent Application No. PCT/EP2020/051373, filed on Jan. 21, 2020, which claims priority to United Kingdom Patent Application No. GB 1900964.6, filed on Jan. 24, 2019, the entire contents of both of which are incorporated herein by reference.

### FIELD OF THE INVENTION

The present invention relates to a method for manufacturing a container from a thermoplastic material, a tool for moulding the container and to containers produced according to the method.

### SUMMARY OF THE INVENTION

According to the present invention there is provided a tool for thermoforming a container having a base and an upstanding sidewall walls or walls, the tool including a mould having a profile shaped to form the exterior shape of the container, a plug adapted to be inserted in the mould to define the interior of the container, the plug having a lower face adapted to define the profile of the base of the container, the profile of the lower face of the plug having at least one groove therein defining, in use, a rib upstanding in the interior of the base of the container, wherein the lower face of the plug has a clamping surface extending around the periphery of the base adjacent the side wall of the container, the clamping surface mating with a corresponding mating surface, on or in the mould to securely clamp the material of the container between the mould and the plug so that the wall of the container and the base of the container can then be subjected to different pressures.

In a preferred embodiment, a plurality of grooves are provided in the plug to form a plurality of ribs upstanding in the interior of the base of the container. In one preferred form, said plurality of grooves are arranged in spaced parallel relationship. In another embodiment, the groove or grooves are arranged to provide a rib or an array of ribs shaped to support a particular type of product.

In another embodiment, the lower face of the plug has a peripheral groove extending around the periphery of the lower face adjacent the side wall of the container, the groove mating with a corresponding peripheral rib upstanding from the base of the mould to clamp the material of the container firmly between the plug and the mould.

In an alternative embodiment, the lower face of the plug has a peripheral rib extending around the periphery of the base adjacent the side wall of the container, the rib mating with a corresponding peripheral groove in the base of the mould to clamp the material of the container firmly between the plug and the mould.

In a preferred embodiment, the profile of the lower face of the plug is formed on an insert secured to the plug. In which case, the insert is located in a recess in the lower face of the plug.

Preferably, the insert is removably secured to the plug to enable the tool to be readily adapted to produce, selectively, a variety of containers having different base profiles.

The present invention also provides a method of manufacturing a container from a sheet of thermoplastic material including a mould shaped to define the exterior profile of the container, placing a sheet of thermoplastic material over the mould, warming the sheet of thermoplastic material to a mouldable temperature, forming the container with a base and an upstanding sidewall wall or walls, providing a plug shaped to provide the internal profile of the container and being adapted to be inserted in the mould to clamp the material to define the container therebetween, forming a lower face of the plug to define the profile of the base of the container, forming at least one groove in the lower face of the plug, applying a vacuum or air pressure to the insert to draw the sheet of material into the at least one groove therein to form a rib upstanding in the interior of the base of the container, including the step of forming in the lower face of the plug a peripheral clamping surface extending around the periphery of the plug adjacent the side wall of the container, the clamping surface mating with a corresponding peripheral clamping surface of the mould to clamp the material of the container securely between the mould and the plug, so that the wall of the container and the base of the container can then be subjected to different pressures.

In a preferred form of the method, the clamping surface in the lower face of the plug is formed with a peripheral rib or groove extending around the periphery of the plug adjacent the side wall of the container, the rib or groove mating with a corresponding clamping surface formed with a peripheral groove or rib, as the case may be, in the base of the mould, so that the wall of the container and the base of the container can then be subjected to different pressures.

### BRIEF DESCRIPTION OF THE DRAWINGS

A preferred embodiment of the present invention will now be described with reference to the accompanying figures in which:

FIG. 1 illustrates a tool for manufacturing a container from a thermo-forming material in a first stage.

FIG. 2 illustrates a tool for manufacturing a container from a thermo-forming material in a second stage.

FIG. 3 illustrates a tool for manufacturing a container from a thermo-forming material in a third stage.

FIG. 4 illustrates a tool for manufacturing a container from a thermo-forming material in a fourth stage.

FIG. 5 illustrates a tool for manufacturing a container from a thermo-forming material in a fifth stage.

FIG. 6 illustrates a tool for manufacturing a container from a thermo-forming material in a sixth stage.

FIG. 7 illustrates a tool for manufacturing a container from a thermo-forming material in a seventh stage.

### DETAILED DESCRIPTION OF EMBODIMENT(S) OF THE INVENTION

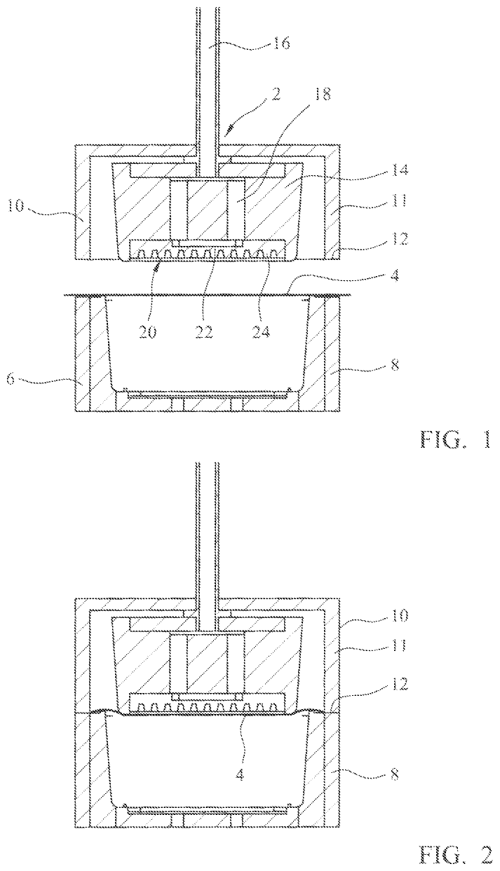

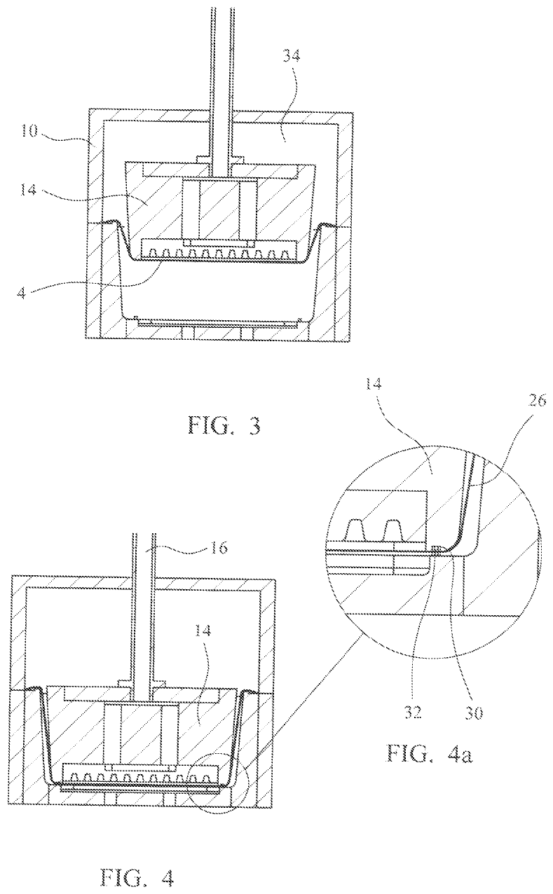

Referring now to FIG. 1 in particular there is shown a tool for manufacturing a container from a thermo-formable plastics material such as polyethylene terephthalate (PET), the container having a peripheral wall 26 and a base 28 and typically being intended for storing and displaying products such as soft fruit for sale in supermarkets and the like. In a practical application, a bank of six or eight of such tools are arranged in a frame (not shown) to produce six or eight containers simultaneously from a large sheet or film of material 4. The container is thus formed as a one-piece moulding which is shaped and cut from a thermoformable sheet or film of material which in this embodiment comprises PET.

A mould 6 which serves to define the outer shape and dimensions of the container is located in the frame 8. A pressure box 10 is positioned above the mould 6 and has a downwardly extending wall 11 the lower edge 12 of which engages with the frame 8 to provide a substantially airtight seal with the sheet of material 4 trapped therebetween. A plug 14 is located in the pressure box 10, the plug 14 having an interior space 18 connected a to a source of vacuum through a vacuum pipe 16. At its lower face 20, the plug has a recess therein in which is located an insert 22 containing a plurality of grooves 24 which define the profile of the base 28 of the container 2. The inner, rear side of the insert 22 is connected to the space 18 so that the insert 22 and the grooves 24 are subjected to vacuum supplied through the vacuum pipe 16. As a result, the material of the base is drawn into the grooves to form a plurality of ribs 25 in the interior of the base of the container, the ribs being in spaced parallel relationship. The size, positioning and shape of the grooves is determined by the intended application and the type of product, such as strawberries, grapes, peaches et cetera for which the container is intended.

Referring now to FIGS. 4 and 4a in particular, the plug 14 has a peripheral groove 30 extending around the periphery of its lower face 20 which in the moulding position engages in a rib 32 located in the base of the mould just inwardly of the peripheral wall 26 of the container. The peripheral groove 30 and rib 32 serve as clamping surfaces to securely clamp the material of the container in position to define and secure the peripheral wall 26 of the container separate from the base. In this way, the seal formed between the wall of the container and the base of the container enables the wall and the base to be subjected to different pressures in the same pressing operation. This not only prevents material from the wall being drawn into the base when the base material is deformed thereby to maintain the rigid strength required for the wall but enables the material of the base to be stretched into the grooves to form a thinner material for the base in these areas thus increasing the flexibility and cushioning effect of the ribs formed in the base of the container.

In an alternative embodiment (not shown) the rib 32 is located on the lower face of the plug and the groove 30 is formed in the base of the mould. In an alternative embodiment (not shown) there is no insert and the plug is formed of a metal such as aluminium and the grooves are machined in the lower face of the plug. In an alternative embodiment in which a peripheral rib is formed on the plug, the material of the plug is machined away to leave the peripheral rib standing proud of the remainder of the lower face of the plug.

As shown in FIG. 2, the pressure box 10 is closed to trap the sheet material 4 between the frame 8 and the lower edge 12 of the pressure box 10. Thereafter, as shown in FIG. 5, air pressure is fed to the space 34 between the pressure box and the plug 12, which urges the plug downwardly until the plug presses the material 4 down until it contacts the base of the mould as shown in FIG. 4. In this position, the sheet material is urged by the rib 32 into the groove 30 where it is clamped securely in position. In this way, the material defining the wall 26 of the container is clamped securely in position so that when further moulding takes place on the material at the base of the plug, the material defining the wall 26 of the container cannot flow into the base 28 of the container 2.

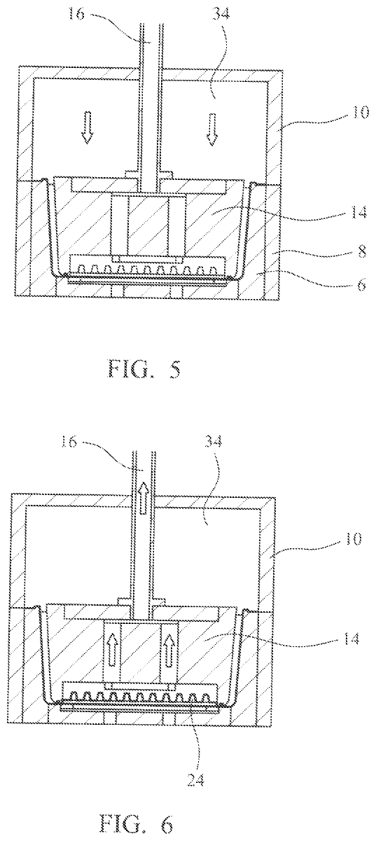

Turning now to FIG. 6, in this stage of the manufacture, a vacuum is applied through the vacuum pipe 16 to the interior of the plug 12 and the vacuum thus draws the material of the base of the container into the grooves 24 to form ribs 25 upstanding in the base of the container. As a consequence, the material of the base 28 of the container 2 is greatly thinned. In this way, the wall of the container remains a relatively thick and rigid material but the material of the ribs 25 in the base 28 of the container are relatively thin and flexible. In this way, the ribs form a cushion to protect, for example, soft fruit such as strawberries during storage and transportation without the necessity of having to insert a cushioning material such as a layer of foamed material, fabric, bubblewrap or the like in the base of the container. This has the great advantage that containers in accordance with the present disclosure are formed entirely of the one single PET material which greatly facilitates recycling of the container after use.

A further advantage is that the additional manufacturing steps currently used of supplying a layer of protective material in the base of the container and gluing it in position are eliminated, which lowers production cost. In an alternative embodiment, instead of using a vacuum to urge the material into engagement with the insert, air pressure could be alternatively or additionally applied to the underside of the material to urge the material up into the grooves in the insert. The temperature of the air pressure may be adjusted to ensure that the base of the container remains sufficiently flexible to ensure that the material is drawn or pressed completely into the grooves.

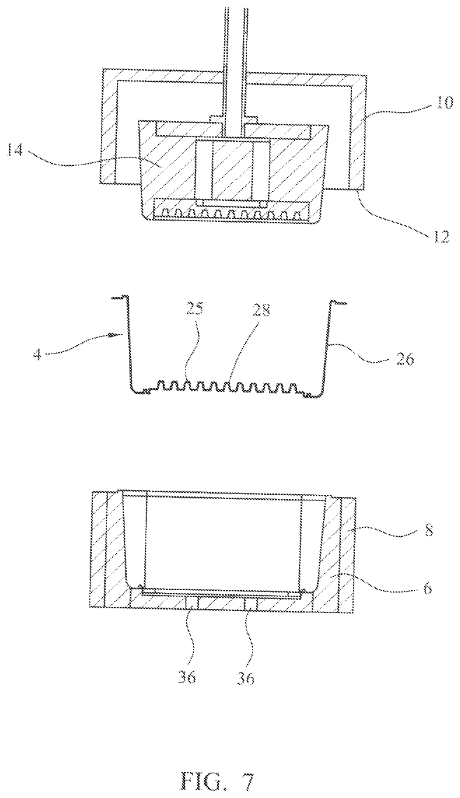

Turning now to FIG. 7, the final stage of manufacturing the container is shown. The pressure box 10 is withdrawn, with the plug 14 and a quick blast of release air is applied to the underside of the mould through air supply openings 36 to release the container from the mould 6, from where it passes to a trimming station where the edge of the container walls are trimmed to a desired finished state. The temperature of the release air is low enough such that it does not affect or distort the shape of the moulded parts of the container.

In the described embodiment, the peripheral clamping surfaces between the plug and the mould comprise a rib on either the plug or the mould which it engages with a groove on the other of the plug or mould but other forms of clamping could be used such as a smooth clamping surface on each of the components which abut to form a complete seal between the two components. The material of the container clamped between the two clamping surfaces may be compressed or deflected to a sufficient extent to seal any minor leaks. In an alternative form, a gasket may be provided between the two clamping surfaces, the gasket being formed of a compatible recyclable material such as the material of the container. The gasket may be formed of an expanded or foamed form of the PET material from which the container is made.

The embodiment described provides a cushioning effect to products stored in the container but in alternative embodiments just one or two ribs could be provided in the base of the container to divide the container into a number of compartments for locating and protecting individual items such as mangoes from damaging each other during transit. In another form, the base of the container may be formed with at least one set of concentric ribs adapted to receive and locate in the container a larger fruit such as a peach. The concentric ribs may increase in height away from the axis of the concentric ribs to form a shaped shallow cup adapted to cushion and locate a larger fruit, for example.

In a further embodiment, the plug has a further clamping surface extending across the container from a first position on the peripheral clamping surface to a 2nd position on the peripheral clamping surface spaced from the first position, the further clamping surface being adapted to engage a further clamping surface of the mould to clamp the material of the container therebetween to define a predetermined area of the base to define and secure the material of the predetermined area of the base separate from the remaining material of the container.

1. A tool for thermoforming a container having a base and an upstanding sidewall walls or walls, the tool including a mould having a profile shaped to form the exterior shape of the container, a plug adapted to be inserted in the mould to define the interior of the container, the plug having a lower face adapted to define the profile of the base of the container, the profile of the lower face of the plug having a plurality of grooves adapted to form a plurality of ribs upstanding in the interior of the base of the container, the ribs being relatively thin and flexible to provide a cushioning effect for the contents of the container, wherein the lower face of the plug has a peripheral groove or rib extending around the periphery of the base adjacent the side wall of the container, the peripheral groove or rib mating with a corresponding peripheral rib or groove, as the case may be, on or in the mould to securely clamp the material of the container between the mould and the plug throughout the moulding process so that the wall of the container and the base of the container can be subjected to different pressures.

2.-3. (canceled)

4. A tool according to claim 1, wherein said plurality of grooves are arranged in spaced parallel relationship.

5. A tool according to claim 1, wherein the profile of the lower face of the plug is formed on an insert secured to the plug.

6. A tool according to claim 5; wherein the insert is located in a recess in the lower face of the plug.

7. A tool according to claim 5, wherein the insert is removably secured to the plug to enable the tool to be readily adapted to produce, selectively, a variety of containers having different base profiles.

8. A method of manufacturing a container from a sheet of thermoplastic material including a mould shaped to define the exterior profile of the container, comprising:
placing a sheet of thermoplastic material over the mould,
warming the sheet of thermoplastic material to a mouldable temperature, the container having a base and an upstanding sidewall wall or walls,
providing a plug shaped to provide the internal profile of the container and being adapted to be inserted in the mould to clamp the material to define the container therebetween,
forming the lower face of the plug with a peripheral groove or rib extending around the periphery of the base adjacent the side wall of the container, the peripheral groove or rib mating with a corresponding peripheral rib or groove, as the case may be, on or in the mould to securely clamp the material of the container between the mould and the plug throughout the moulding process, so that the wall of the container and the base of the container can be subjected to different pressures,
forming a lower face of the plug to define the profile of the base of the container,
forming a plurality of grooves in the lower face of the plug,
applying a vacuum or pressurized air to the insert to draw or press the sheet of material into the grooves therein to form ribs upstanding in the interior of the base of the container, and
thereby stretching the material of the ribs to form a thinner material for the ribs thus increasing the flexibility of the ribs to provide a cushioning effect for the contents of the container.

9.-15. (canceled)

16. A tool according to claim 1, wherein ribs are provided in the base of the container to divide the container into a number of compartments for locating and protecting individual items from damaging each other during transit.

17. A tool according to claim 1, wherein the ribs comprise at least one set of concentric ribs adapted to receive and locate in the container a large fruit.

18. A tool according to claim 17, wherein the concentric ribs increase in height away from the axis of the concentric ribs to form a shaped shallow cup adapted to cushion and locate a fruit.

19. A method according to claim 8, wherein one or two ribs are provided in the base of the container to divide the container into a number of compartments for locating and protecting individual items from damaging each other during transit.

20. A method according to claim 8, wherein the ribs comprise at least one set of concentric ribs adapted to receive and locate in the container a large fruit.

21. A method according to claim 20, wherein the concentric ribs increase in height away from the axis of the concentric ribs to form a shaped hollow cup adapted to cushion and locate a fruit.
